(19) United States
(12) Patent Application Publication
(10) Pub. No.: US 2013/0135858 A1
(43) Pub. Date: May 30, 2013

(54) LIGHTING BULB

(71) Applicants: Hsien-Chang Wu, New Taipei City (TW); Jian Li, Shanghai (CN); Wei Zhou, Shanghai (CN); Jun Zhang, Shanghai (CN)

(72) Inventors: Hsien-Chang Wu, New Taipei City (TW); Jian Li, Shanghai (CN); Wei Zhou, Shanghai (CN); Jun Zhang, Shanghai (CN)

(73) Assignees: GE Lighting Solutions, LLC, Cleveland, OH (US); Cal-Comp Electronics & Communications Company Limited, New Taipei City (TW)

(21) Appl. No.: 13/327,783

(22) Filed: Dec. 16, 2011

(30) Foreign Application Priority Data
Nov. 29, 2011 (CN) 201110386852.5

(51) Int. Cl. F21V 5/04; F21V 15/01; F21V 29/00

(52) U.S. Cl. 362/235; 362/373; 362/249.01; 362/249.02

(57) ABSTRACT

A lighting bulb is provided. The lighting bulb has a housing, a lighting unit and an electrical connector. The housing is configured for accommodating a circuit board and a heat-dissipating sealant is filled in the housing. The lighting unit is coupled to the circuit board for emitting the light and the electrical connector is configured for providing power to the circuit board and the lighting unit. A protruding member disposed on the inner surface of the housing and the circuit board form a mechanical interference against the floating force of the heat-dissipating sealant to the circuit board.

### CROSS-REFERENCE TO RELATED APPLICATION

This application claims the priority benefit of China application serial no. 201110386852.5, filed on Nov. 29, 2011. The entirety of the above-mentioned patent application is hereby incorporated by reference herein and made a part of this specification.

### BACKGROUND OF THE INVENTION

1. Field of the Invention

The present invention generally relates to a lighting bulb, in particular, to a lighting bulb easily assembled, having smooth appearance and having better heat dissipation efficiency.

2. Description of Related Art

Referring to FIGS. 1 and 2, a conventional LED lighting bulb 100 includes a housing 102, a circuit board 106 accommodated in the housing 102, a lighting unit 110 and an electrical connector 112. The electrical connector 112 provides power to the circuit board 106 and the lighting unit 110 as the lighting bulb 100 is lighted up so that the circuit board 106 and the LEDs (not shown) disposed in the lighting unit 110 must generate a large amount of heat.

The heat generated by the LEDs can be easily conducted to the heat sink 114 located outside the lighting unit 110 and then the heat can be dissipated from the heat sink 114 into the air. However, the heat generated by the circuit board 106 is not easy to be dissipated into the air through the housing 102 if the space between the circuit board 106 and the housing 102 is empty. Therefore, referring to FIG. 1, before the housing 102 and the lighting unit 110 are assembled, a sealant 108 for heat-dissipation is used to fill into the remaining space of the housing 102, not occupied by the circuit board 106, and then the sealant 108 is cured by heat or UV light. By the way, most of the heat generated by the circuit board 106 can be easily delivered to the housing 102 through the heat-dissipation sealant 108.

However, the circuit board 106 is floated up to a height over the predetermined position before the sealant 108 is cured, and the circuit board 106 cannot be pressed back when the sealant 108 has been cured. It could be found that there is a gap shown between the housing 102 and the lighting unit 110 as they are assembled. Therefore, an additional ring 104 disposed between the housing 102 and the lighting unit 110 or the structural modification of the housing 102 is necessary to seal the gap as described previously.

Since the heat sink 114 doesn't contact the housing 102 directly, it may affect the heat transduction efficiency between the housing 102 and the heat sink 114. Furthermore, the additional seal ring 104 between the housing 102 and the heat sink 114 or the structural modification of the housing 102 makes the appearance of the lighting bulb 100 is not smooth enough.

### SUMMARY OF THE INVENTION

Accordingly, the present invention is directed to a lighting bulb easily assembled.

The present invention is directed to a lighting bulb having smooth appearance and having better heat dissipation efficiency.

According to an embodiment of the present invention, a lighting bulb is provided. The lighting bulb has a housing, a lighting unit and an electrical connector. The housing is configured for accommodating a circuit board and a heat-dissipating sealant is filled in the housing. The lighting unit is coupled to the circuit board for emitting the light and the electrical connector is configured for providing power to the circuit board and the lighting unit. A protruding member disposed on the inner surface of the housing and the circuit board form a mechanical interference against the floating force of the heat-dissipating sealant to the circuit board.

According to an embodiment of the present invention, the circuit board has a notch and the protruding member extends into the notch of the circuit board to form the mechanical interference.

According to an embodiment of the present invention, the circuit board has an opening and the protruding member extends into the opening of the circuit board to form the mechanical interference.

According to an embodiment of the present invention, the protruding member is integrally formed with the housing.

According to an embodiment of the present invention, the protruding member is adhered to the inner surface of the housing.

According to an embodiment of the present invention, the heat-dissipating sealant comprises a heat-curable resin or a UV-curable resin.

According to an embodiment of the present invention, the lighting unit comprises a heat sink disposed on the housing and a plurality of lighting devices disposed onto the heat sink and coupled to the circuit board.

According to an embodiment of the present invention, the lighting devices comprise light emitting diodes.

According to an embodiment of the present invention, the lighting unit further comprises a lens coupled to the heat sink and covering the lighting devices.

According to an embodiment of the present invention, the lens comprises transparent, translucent or light transmissible white materials.

According to an embodiment of the present invention, the electrical connector is configured for engagement into a standard lighting bulb base socket.

According to an embodiment of the present invention, the standard lighting bulb base socket comprises a threaded base socket.

According to another embodiment of the present invention, a lighting bulb is provided. The lighting bulb has a housing, a lighting unit and an electrical connector. The housing is configured for accommodating a circuit board and a heat-dissipating sealant is filled in the housing. The lighting unit is coupled to the circuit board for emitting the light and the electrical connector is configured for providing power to the circuit board and the lighting unit. A portion of the circuit board is engaged into a recess on the inner surface of the housing to form a mechanical interference against the floating force of the heat-dissipating sealant to the circuit board.

According to the description above, by using the mechanical interference between the circuit board and the housing, the circuit board accommodated in the housing is not affected by the floating force of the sealant filled in the housing, therefore an additional seal ring or any housing modification is not necessary for the lighting bulb of the present invention, and a better heat transduction efficiency and a smooth appearance for the light bulb of the present invention can be obtained.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an partially exploded schematic diagram of a conventional lighting bulb.

FIG. 2 is an assembled diagram of the above-mentioned conventional lighting bulb.

FIG. 3 is an partially exploded schematic diagram of a lighting bulb according to an embodiment of the present invention.

FIG. 4A is a cross-sectional view of a housing of the lighting bulb shown in FIG. 3.

FIG. 4B is a top view of the housing of the lighting bulb shown in FIG. 4A.

FIG. 5 is a schematic diagram of a circuit board of the lighting bulb shown in FIG. 3.

FIG. 6 is a cross-sectional view for an assembled diagram of the lighting bulb shown in FIG. 3.

FIG. 7 is the assembled diagram of the lighting bulb shown in FIG. 3.

FIG. 8 is a cross-sectional view for an assembled diagram of a lighting bulb according to another embodiment of the present invention.

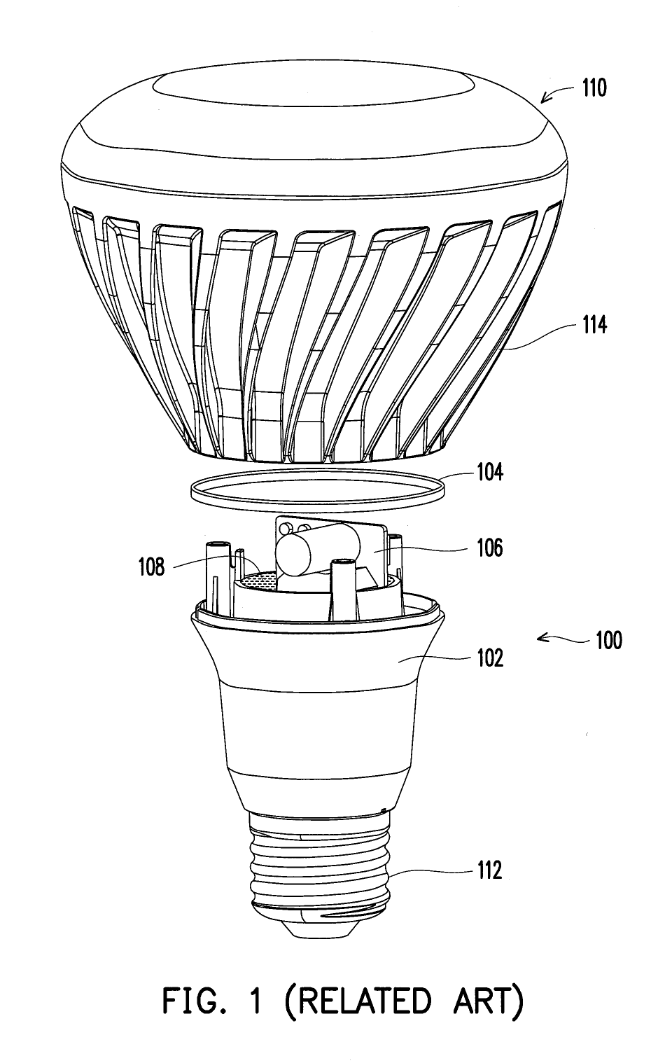

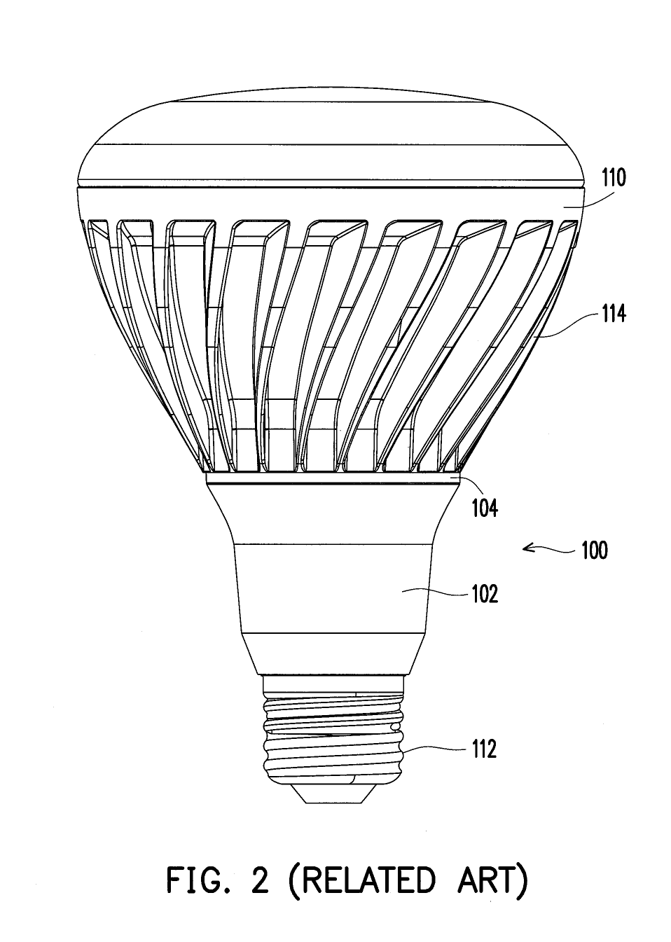

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

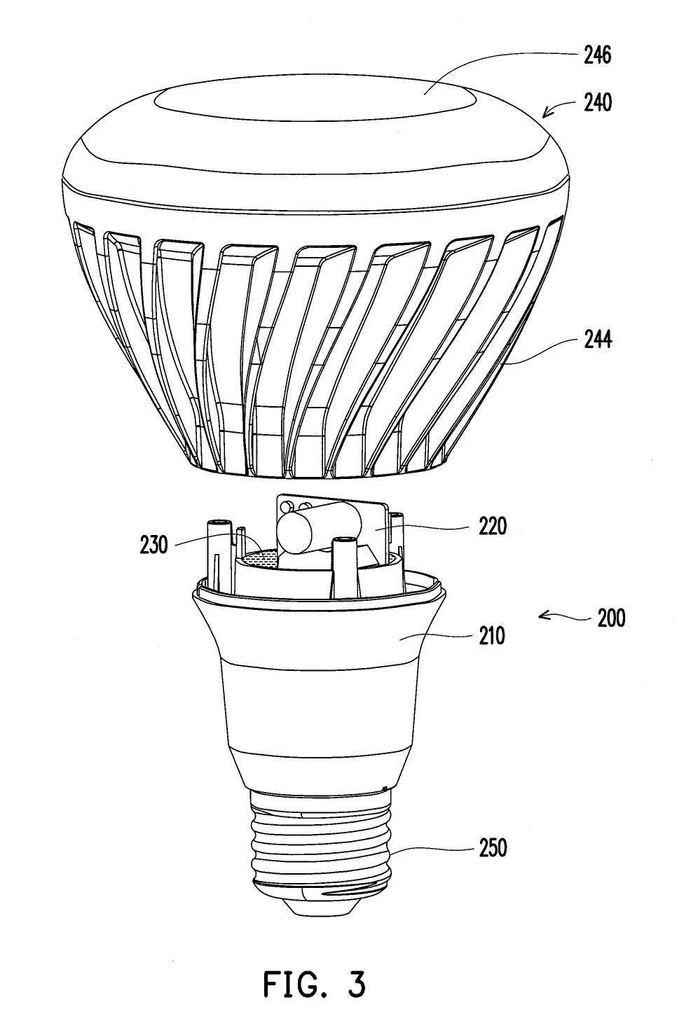

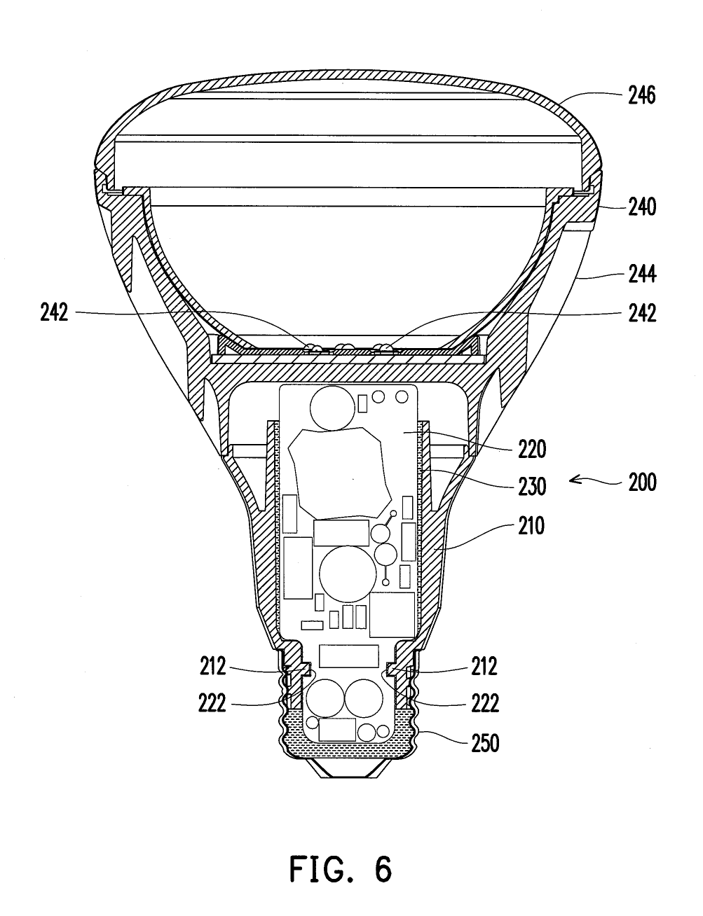

FIG. 3 is an partially exploded schematic diagram of a lighting bulb 200 according to an embodiment of the present invention. FIG. 6 is a cross-sectional view for an assembled diagram of the lighting bulb shown in FIG. 3. Referring to FIGS. 3 and 6, the lighting bulb 200 at least comprises a housing 210, a circuit board 220 accommodated in the housing 210, a lighting unit 240 and an electrical connector 250. A sealant 230 for heat-dissipation is applied into the housing 210 for filling the remaining space in the housing 210 not occupied by the circuit board 220. The heat-dissipation sealant 230 includes a heat-curable resin or a UV-curable resin, for example. Before the sealant 230 is cured, the sealant 230 exerts a floating force onto the circuit board 220.

The lighting unit 240 at least comprises a heat sink 244 disposed on the housing 210 and a plurality of lighting devices 242, disposed onto the heat sink 244, coupled to the circuit board 220. In an embodiment of the present invention, the lighting devices 242, for example, are light emitting diodes (LEDs). The lighting unit 240 further comprises a lens 246 coupled to the heat sink 244 and covering the lighting devices 242 disposed on the heat sink 244. The lens 246 includes transparent, translucent or light transmissible white materials and at least a portion of the light emitted by the lighting devices 242 can pass through the lens 246.

In an embodiment of the present invention, the electrical connector 250 is configured for engagement into a standard lighting bulb base socket which is the threaded base socket, for example. The electrical connector 250 provides the mechanical support of the housing 210 and the lighting unit 240 and provides power to the circuit board 220 and the lighting devices 242. When the lighting bulb 200 is lighted up, the circuit board 220 and the lighting devices 242 disposed in the lighting unit 110 generate a large amount of heat. The heat generated by the lighting devices 242 can be conducted to the heat sink 244 located outside the lighting unit 240 and then the heat can be dissipated from the heat sink 244 into the air. After the sealant 230 is cured by heat or UV light, the heat generated by the circuit board 220 can be rapidly conducted to the housing 210 through the cured heat-dissipation sealant 230.

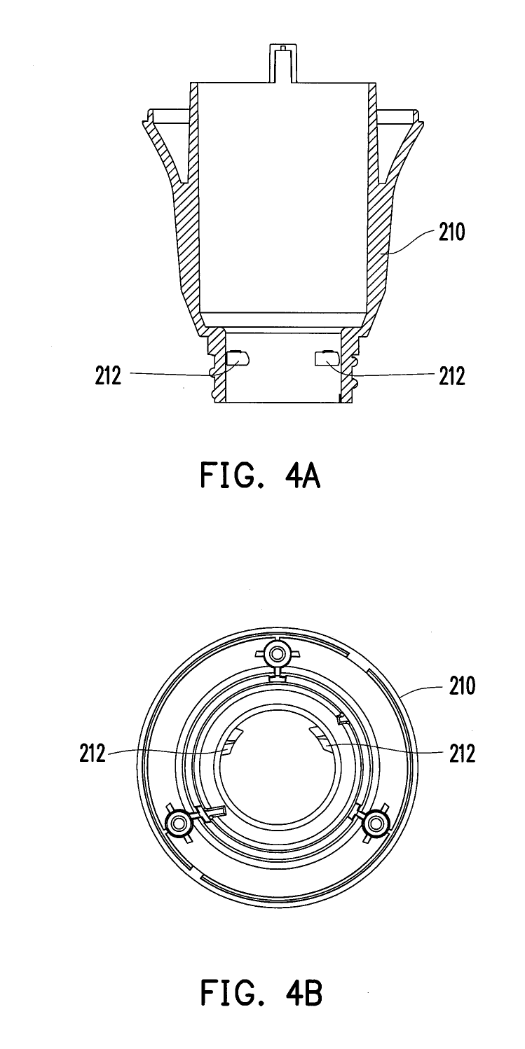

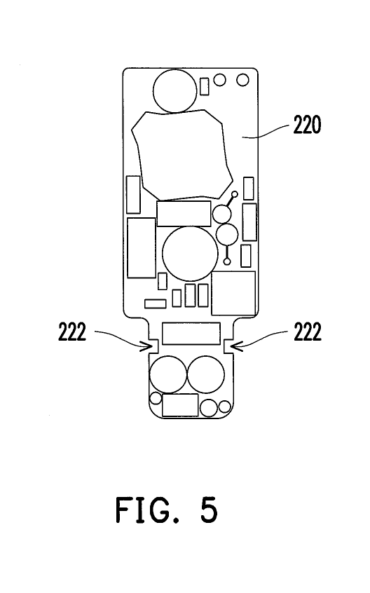

FIG. 4A is a cross-sectional view of the housing 210 of the lighting bulb 200 shown in FIG. 3, and FIG. 4B is a top view of the housing 210 of the lighting bulb 200 shown in FIG. 4A. Referring to FIGS. 4A and 4B, it could be found that protruding members 212 are formed on the inner surface of the housing 210. In an embodiment of the present invention, the protruding members 212 is protruding pins or bumps, for example. The protruding members 212 are integrally formed with the housing 210 or are adhered to the inner surface of the housing 210. Referring to FIG. 5, the circuit board 220 has two notches 222 formed on each lateral thereof, corresponding to the protruding members 212 of the housing 210. As assembling the lighting bulb 200 according to one embodiment of the present invention, the circuit board 220 is inserted into the inner space of the housing 210 and then is rotated along the central vertical axis of the circuit board 220 to render each of the notches 222 of the circuit board 220 to gradually align each of the protruding members 212 of the housing 210, respectively. Finally, the protruding members 212 extend into the notched 222 so that the mechanical interferences between the circuit board 220 and the protruding members 212 are formed in the vertical direction.

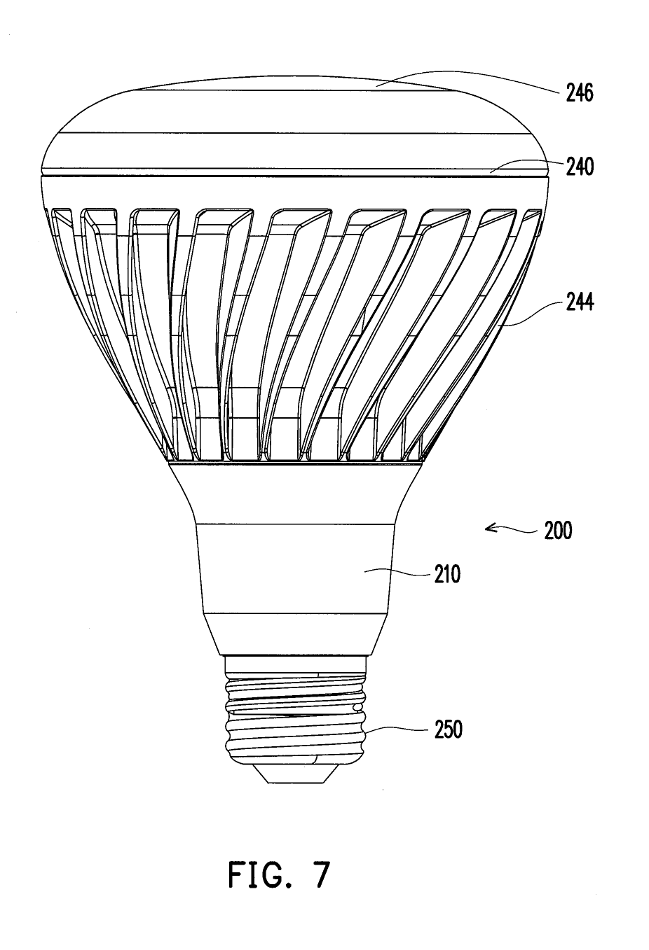

As mentioned above, when the heat-dissipation sealant 230 is filled into the inner space of the housing 210, the sealant 230 must exert a upward floating force onto the circuit board 220 before cured. The mechanical interferences between the circuit board 220 and the protruding members 212 can resist the floating force of the sealant 230 and stay the circuit board 220 at the predetermined position. Therefore, as the sealant 230 is cured, the circuit board 220 is fixed in the housing 210, so that the heat sink 244 of the lighting unit 240 and the housing 210 accommodating the circuit board 220 and the cured sealant 230 can be assembled closely and easily. Referring to FIGS. 6 and 7, the lighting bulb 200 according to one embodiment of the present invention can obtain a smooth appearance and a better heat dissipation efficiency, and no more seal ring between the heat sink 244 and the housing 210 or modified housing 210 is needed.

In other embodiment of the present invention, the circuit board 220 has at least one opening (not shown) formed thereon. As assembling the lighting bulb 200, the circuit board 220 is inserted into the inner space of the housing 210 and then the opening of the circuit board 220 can align one of the protruding members 212 of the housing 210. Finally, the protruding member 212 extends into the opening so that the mechanical interference between the circuit board 220 and the protruding member 212 is formed in the vertical direction against the floating force of the sealant 230 as mentioned previously.

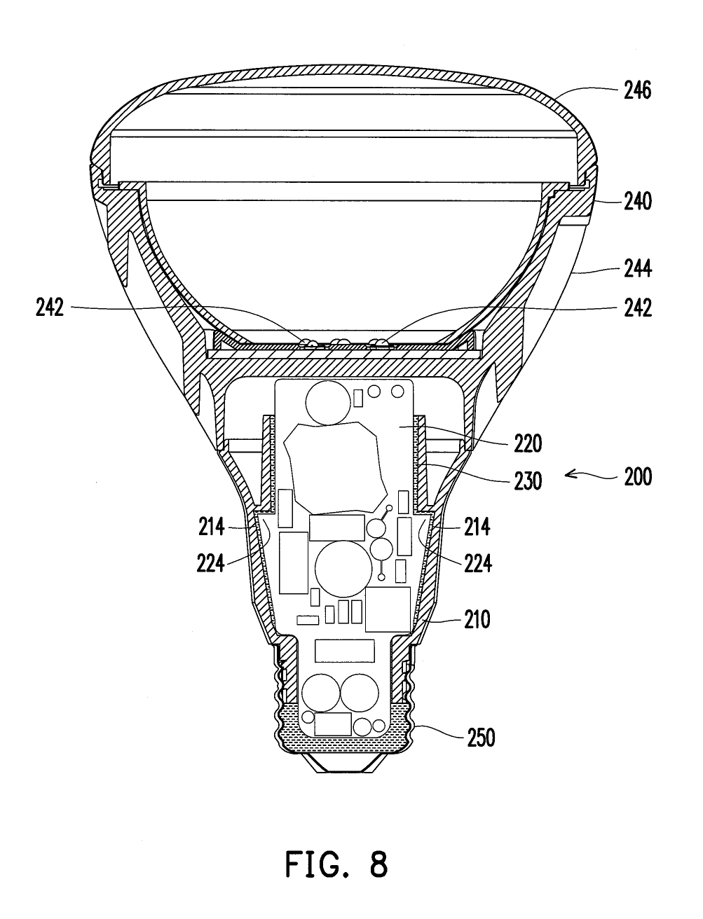

FIG. 8 is a cross-sectional view for an assembled diagram of a lighting bulb 200 according to another embodiment of the present invention. In this embodiment, elements of the lighting bulb 200 in functions identical to or similar to the elements of that shown in FIGS. 3, 6 and 7 are not repeated again and the previous descriptions can be referred for details. In previous embodiments, the circuit board 220 and the housing 210 form the mechanical interferences between the protruding members 212 and the notches 222 or openings of the circuit board 220.

Referring to FIG. 8, however, in this embodiment of the present invention, recesses 214 can be formed on the inner surface of the housing 210 and protruding portions 224 of the circuit board 220 can be engaged into the recesses 214 of the housing 210 as the circuit board 220 is inserted into the housing 210, such that the mechanical interferences in the vertical direction between the housing 210 and the circuit board 220 can also be formed. Therefore, the mechanical interferences can also work against the floating force of the sealant 230 on the circuit board 220, and as mentioned above, the heat sink 244 of the lighting unit 240 and the housing 210 accommodating the circuit board 220 and the cured sealant 230 can be assembled closely and easily.

According to the description above, by using the mechanical interference between the circuit board and the housing, the circuit board accommodated in the housing is not affected by the floating force of the sealant filled in the housing, therefore an additional seal ring or any housing modification is not necessary for the lighting bulb of the present invention, and a better heat transduction efficiency and a smooth appearance for the light bulb of the present invention can be obtained.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lighting bulb comprising:
a housing configured for accommodating a circuit board and a heat-dissipating sealant filled therein;
a lighting unit coupled to the circuit board for emitting the light; and
an electrical connector configured for providing power to the circuit board and the lighting unit, wherein a protruding member disposed on the inner surface of the housing and the circuit board form a mechanical interference against the floating force of the heat-dissipating sealant to the circuit board.

2. The light bulb according to claim 1, wherein the circuit board has a notch and the protruding member extends into the notch of the circuit board to form the mechanical interference.

3. The light bulb according to claim 1, wherein the circuit board has an opening and the protruding member extends into the opening of the circuit board to form the mechanical interference.

4. The light bulb according to claim 1, wherein the protruding member is integrally formed with the housing.

5. The light bulb according to claim 1, wherein the protruding member is adhered to the inner surface of the housing.

6. The light bulb according to claim 1, wherein the heat-dissipating sealant comprises a heat-curable resin or a UV-curable resin.

7. The light bulb according to claim 1, wherein the lighting unit comprises a heat sink disposed on the housing and a plurality of lighting devices disposed onto the heat sink and coupled to the circuit board.

8. The light bulb according to claim 7, wherein the lighting devices comprise light emitting diodes.

9. The light bulb according to claim 7, wherein the lighting unit further comprises a lens coupled to the heat sink and covering the lighting devices.

10. The light bulb according to claim 9, wherein the lens comprises transparent, translucent or light transmissible white materials.

11. The light bulb according to claim 1, wherein the electrical connector is configured for engagement into a standard lighting bulb base socket.

12. The light bulb according to claim 11, wherein the standard lighting bulb base socket comprises a threaded base socket.

13. A lighting bulb comprising:
a housing configured for accommodating a circuit board and a heat-dissipating sealant filled therein;
a lighting unit coupled to the circuit board for emitting the light; and
an electrical connector configured for providing power to the circuit board and the lighting unit, wherein a portion of the circuit board is engaged into a recess on the inner surface of the housing to form a mechanical interference against the floating force of the heat-dissipating sealant to the circuit board.

14. The light bulb according to claim 13, wherein the heat-dissipating sealant comprises a heat-curable resin or a UV-curable resin.

15. The light bulb according to claim 13, wherein the lighting unit comprises a heat sink disposed on the housing and a plurality of lighting devices disposed onto the heat sink and coupled to the circuit board.

16. The light bulb according to claim 15, wherein the lighting devices comprise light emitting diodes.

17. The light bulb according to claim 15, wherein the lighting unit further comprises a lens coupled to the heat sink and covering the lighting devices.

18. The light bulb according to claim 17, wherein the lens comprises transparent, translucent or light transmissible white materials.

19. The light bulb according to claim 13, wherein the electrical connector is configured for engagement into a standard lighting bulb base socket.

20. The light bulb according to claim 19, wherein the standard lighting bulb base socket comprises a threaded base socket.
